(19) United States
(12) Patent Application Publication
(10) Pub. No.: US 2011/0103731 A1
(43) Pub. Date: May 5, 2011

(54) Anti-rotational locking device for a roller bearing

(76) Inventors: Glen R. Fahrni, City of Dalton, OH (US); Gregory C. Piotrowski, City of North Canton, OH (US)

(21) Appl. No.: 11/631,457

(22) PCT Filed: May 19, 2005
(86) PCT No.: PCT/US05/17645

§ 371 Date: Sep. 9, 2008

Related U.S. Application Data
(60) Provisional application No. 60/585,783, filed on Jul. 6, 2004.

(51) Int. Cl. F16C 33/48; B21D 53/10

(52) U.S. Cl. 384/572; 29/898

(57) ABSTRACT

An anti-rotational locking device (8) for a roller bearing assembly (A) having an annular ring (50) attached to an outer race (24) of the roller bearing assembly (A), an outer lip (52) extending from the annular ring (50), an inner lip (54) extending from the annular ring (50), the inner lip (54) being capable of engagement by a tool (58) for adjusting the bearing setting of the roller bearing assembly (A) within a housing (2), and a fastener (70) being capable of engaging the outer lip (52) to secure the roller bearing assembly (A) at a desired bearing setting.

### CROSS-REFERENCE TO RELATED APPLICATIONS

This application claims priority to U.S. provisional application Ser. No. 60/585,783 filed Jul. 6, 2004 entitled ANTI-ROTATIONAL LOCKING DEVICE and which is incorporated herein by reference.

### BACKGROUND ART

Single row tapered roller bearings mounted in opposition find widespread use in machinery for enabling one machine component to rotate relative to another machine component. For example, in many automotive vehicles, the hubs to which nondriven wheels are attached rotate about a fixed shaft (spindle), each on two single row tapered roller bearings mounted, in opposition so that the bearings will transfer axial (thrust) loads in both axial directions as well as radial loads. Likewise, shafts rotate in a housing on tapered roller bearings mounted in opposition. While for each installation it may be desirable to have the races of the two bearings installed with interference fits so as to provide maximum stability, often at least one race is installed with a loose fit so that it can be moved axially to adjust the setting of the bearings. Sometimes, it is the outer race (cup) for one of the bearings, and this is particularly true for the bearings that support the carrier of an automotive differential. Once the correct setting of the bearings is attained, the bearing race with the loose fit should be secure at least in a fixed axial position to retain the setting.

However, in current designs the race with the loose fit can still turn rotationally, which results in wear and premature failure of the race and its mating component, such as a housing. Also, installation of current designs can be time consuming.

### BRIEF DESCRIPTION OF THE DRAWINGS

In the accompanying drawings which form part of the specification:

FIG. 1 is a sectional view of a bearing arrangement, which is provided with an antirotational locking device constructed in accordance with and embodying the present invention;

FIG. 2 shows a bearing outer race provided with an antirotational locking device in perspective constructed in accordance with and embodying the present invention;

FIG. 3 is a perspective view of the antirotational locking device attached to the bearing outer race, a set screw, and a housing;

FIG. 4 is a perspective view of the antirotational locking device engaged with a housing;

FIG. 5 is a sectional view of the set screw engaged with a locking ring; and

FIG. 6 is a perspective view of an adjustment tool being capable of engaging and rotating the antirotational locking device and the outer race to which it is attached.

Corresponding reference numerals indicate corresponding parts throughout the several figures of the drawings.

### BEST MODES FOR CARRYING OUT THE INVENTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

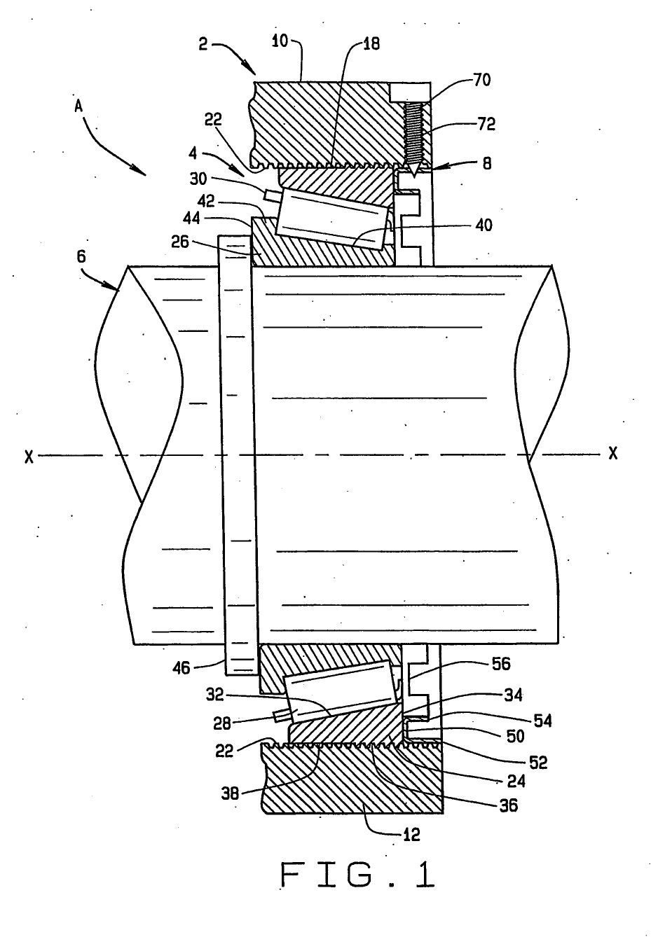

Referring now to the drawings, FIG. 1 depicts a bearing assembly A which includes a housing 2, a single row tapered roller bearing 4 coupled with the housing 2 and mounted to a shaft 6, and an antirotational locking device 8 attached to an outer race 24, or cup, of the bearing 4. Although not shown, a second bearing assembly B similar to bearing assembly A is mounted to the shaft 6 in opposition to bearing assembly A in the direct configuration. As such, the bearing assemblies A and B confine the shaft 6 axially about axis X, while leaving it free to rotate. In addition, the antirotational locking device 8 prevents the loss of a bearing setting by preventing the outer race 24 from backing away, or unthreading, from its original setup axial position, which will be described in further detail below.

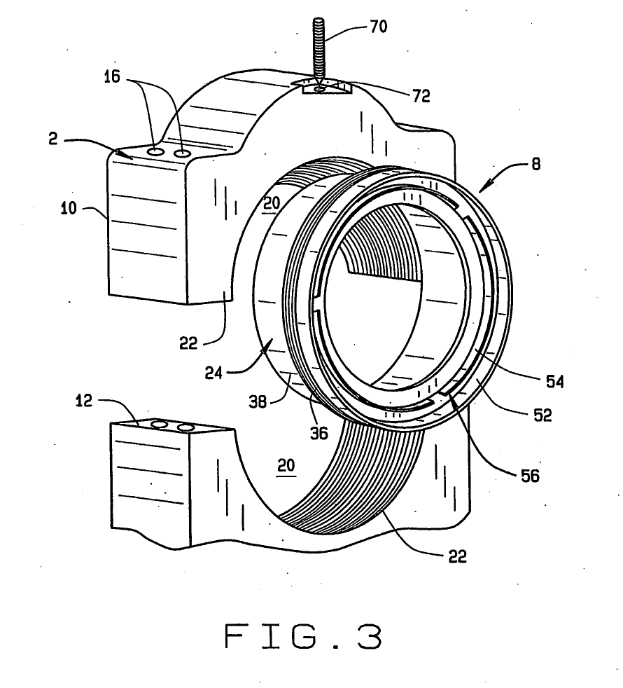

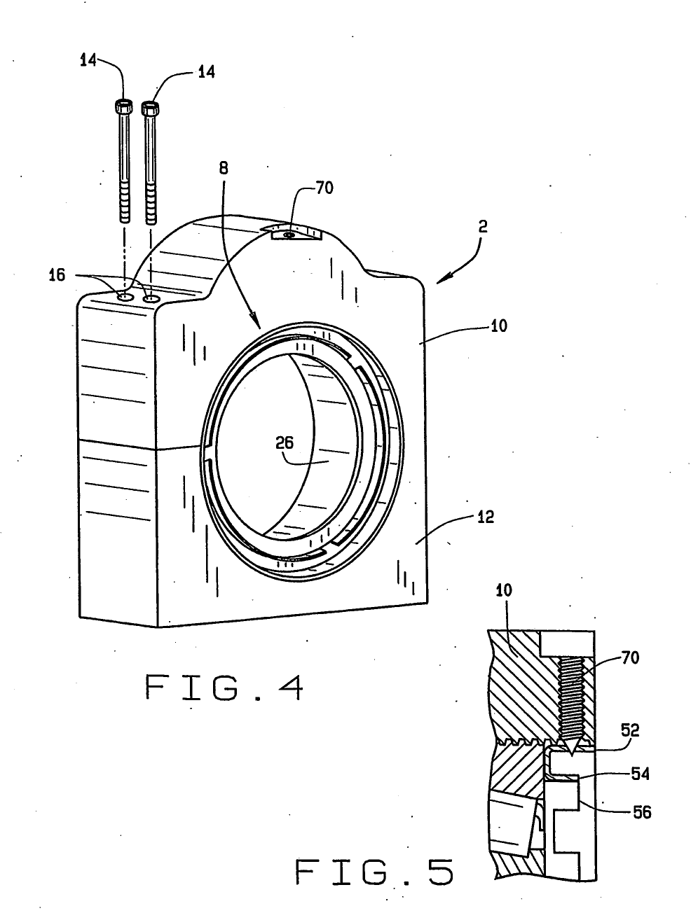

In a preferred embodiment, the housing 2 is a split-type housing (FIGS. 3-4) including a top half pedestal 10 and a bottom half pedestal 12, which can be secured by inserting cap screws 14 through holes 16. Along the axis X, the housing 2 has a bearing seat 18 in the form of half bores 20, which open to the interior of the housing 2. Each half bore 20 contains an internal thread 22, which is of uniform diameter. In other words, the bearing seat 18 is threaded. Each thread 22 has truncated crests, but its roots are V-shaped. The outer race 24 fits into the bearing seat 18.

Of course, the threads 22 of the bearing seat 18 are cut before the outer race 24 is installed in the seat 18. To produce the thread 22 in the seat 18, the top half 10 is secured to the bottom half 12 with the cap screws 14. Then, a boring tool having a diameter corresponding to the diameter of the truncated crests on the thread 22 is run through the bores 20 in which the seat 18 is to be formed. Next, the thread 22 is cut.

The bearing 4 (FIG. 1) includes the outer race in the form of a cup 24, an inner race in the form of a cone 26 located within the cup 24, and rolling elements in the form of tapered rollers 28 arranged in a row between the cup 24 and cone 26. The bearing 4 also includes a cage 30 in its row of tapered rollers 28 to maintain the correct spacing between the rollers 28. The axis of the bearing 4 coincides with the axis X.

The bearing cup 24 has a tapered raceway 32 which is presented inwardly toward the axis X and a back face 34 at the small end of the raceway 32. The back face 34 lies perpendicular to the axis X. Along the cups outwardly presented surface, that is its OD, the cup 24 has a thread 36 and a smooth cylindrical surface 38 beyond the thread 36. The thread 36 occupies between 33% and 50% of the length of the cup 24 and extends from the back face 34 toward the opposite end of the cup 24. Thus, it encircles the cup 24 at the small end of the tapered raceway 32. The pitch and diameter of the thread 36 correspond to the pitch and diameter of the thread 22 of the seat 18 in the sense that the thread 36 will engage the thread 22, although with a slight clearance. Actually, the difference between the pitch diameters of the two threads 22 and 36 should range between 0.0030 and 0.0190 inches. The diameter of the cylindrical surface 38 exceeds the minor or least diameter for the external threads 36 on the cup 24 and is less than the diameter for the internal thread 22 on the bearing seat 18 at the truncated crests of the thread 22. The difference between the diameter of the cylindrical surface 38 and the diameter of the truncated crests for the thread 22 should range between 0.0005 and 0.0030 inches.

Preferably, the cup 24 is formed from steel that is induction hardened along its raceways 32, but not elsewhere. Alternatively, the cup 24 could be formed from case carburized steel and the threads 36 hard turned.

The cone 26 lies within the cup 24 of the bearing 4 and has a tapered raceway 40 Which is presented outwardly away from the axis X and toward the cup raceway 32. The cone 26 at the large end of its raceway 40 has a thrust rib 42 and at the end of the thrust rib 42 a back face 44 which is perpendicular to the axis X.

The tapered rollers 28 for the bearing 4 lie in a single row between the raceways 32 and 40 of the cup 24 and cone 26. They contact the raceways 32 and 40 along their tapered side faces, while their large end faces bear against the thrust rib 42 of the cone 26. The rollers 28 are on apex, meaning that the conical envelopes in which their tapered side faces lie have their apices at a common point along the axis X. The apices for the conical envelopes for the raceways 32 and 40 lie at the same point.

The cone 26 for the bearing 4 fits over the shaft 6, preferably with an interference fit. Its back face 44 bears against a shaft shoulder 46. The cage 30 holds the rollers 28 around the raceway 40 of the cone 26, so that the cone 26 and rollers 28 are installed as a unit known as a cone assembly. The cup 24 for the bearing 4 threads into the bearing seat 18, its external thread 36 engaging the internal thread 22 of the seat 18.

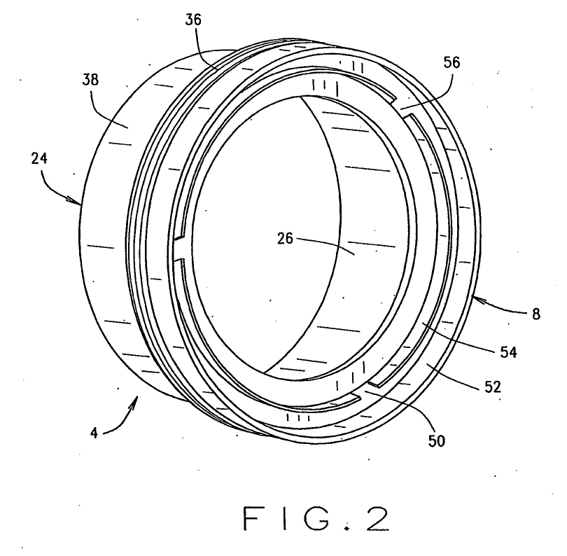

Before the bearing 4 is installed, it is fitted with the antirotational locking device 8 (FIGS. 1-5), which may be formed as a sheet metal stamping. The antirotational locking device 8 is an annular ring 50 having an uninterrupted outer lip 52 and a notched inner lip 54 extending outwardly from the back face 34 of the cup 24. The antirotational locking device 8 is attached to the bearing 4 by welding the ring 50 to the back face 34 of the cup 24. In this way, the antirotational locking device 8 remains with the cup 24 and is configured for engagement by an adjustment tool 58. Welding of the antirotational locking device 8 to the cup 24 provides increased holding power over designs using pins to secure the antirotational locking device 8 to the cup 24.

When the bearing 4 is installed, the antirotational locking device 8 is secured against rotation in the housing 2 with a fastener, such as a cone point or needle point set screw 70 of any type, including slotted, Philips, square, hex socket or any other type head, advanced through a threaded hole 72 of the top half pedestal 10 of the housing 2, until the point of the set screw 70 dimples or penetrates through the outer lip 52 of the antirotational locking device 8. The engagement of the set screw 70 with the housing 2 and with the antirotational locking device 8 welded to the cup 24, connects the cup 24, antirotational locking device 8, screw 70 and housing 2 together, thus preventing the cup 24 from turning/rotating/spinning in the housing 2. The set screw 70 may engage the outer lip 52 at any point, and therefore, the use of a set screw 70 with the uninterrupted outer lip 52 provides for infinite rotational positioning of the cup 24. The width of the outer lip 52 is based on the axial tolerance stackup of all affected components in bearing assemblies A and B, so there will always be enough outer lip 52 available for a set screw 70 to engage the outer lip 52.

In an alternate embodiment, the top half pedestal 10 does not have a threaded hole 72 for advancing the set screw 70. Rather, the set screw 70 is a self-tapping screw, which is drilled through an unthreaded hole of the top half pedestal 10 of the housing 2 until it engages the outer lip 52 of the antirotational locking device 8.

The inner lip 54 has notches 56 which are arranged at equal circumferential intervals and are exposed beyond the back face 34 of the cup 24, all to provide formations, which may be engaged to rotate the cup 24 by an adjustment tool 58. While serving to couple the tool 58 to the cup 24 so as to adjust the location of the bearings 4 axially along the axis X, the antirotational locking device 8 serves the equally important function of securing the cup 24 against rotation, backing away, or unthreading, once it is rotated to the correct bearing setting in the bearing seat 18. In addition, this prevents wear between bearing 4. outside diameter and housing 2 inside diameter in both threaded areas and unthreaded areas of the cup 24 and housing 2.

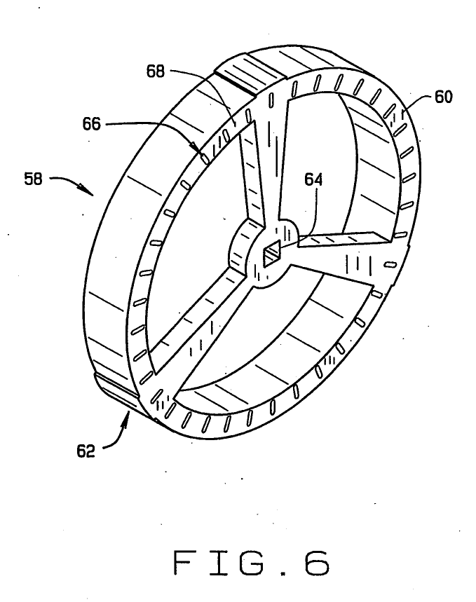

The tool 58 (FIG. 6) takes the form of a disk 60 having tabs 62 along its periphery and a drive socket 64 at its center. It is configured to fit over or into antirotational locking device 8 with its tabs 62 received in the notches 56, so that disk 60 and antirotational locking device 8 are engaged and will rotate in unison. This rotation may be effected by a wrench that engages the tool at its drive socket 64. Indeed, the tool 58 is engaged with the antirotational locking device 8 on each cup 24 of bearing assemblies A and B, and the cups 24 are rotated with the tool 58 to give the bearings 4 the proper setting. The tool 58 also contains incremental marks 66 on its outer face 68, to aid in providing proper angular rotation to obtain correct bearing adjustment, if needed.

The cone 26 and its rollers 28, that is, the cone assembly, need to be installed over the shaft 6 before the housing 2 is fitted to the cup 24. Once the cone 26 is fitted to the shaft 6, the cups 24 are fitted around the rollers 28 that are located around the cones 26. In other words, the bearing 4 is installed around the shaft 6. With the bearing 4 fitted to the shaft 6, the housing top half 10 is secured to the bottom half 12 such that the bearing 4 drops into the half bores 20. The cup 24 may require a slight rotation clockwise or counterclockwise to insure that the thread 36 on it engages the thread 22 of the half bore 20 in which the cup 24 locates. A fixture may be used to hold the cups 24 in place, thus insuring that the bearings 4 remain with the shaft 6 as it is lowered into the bottom half 12 of the housing 2. In this way, the threads 36 in the cup 24 engage the threads 22 of the bottom half 12. The top half pedestal 10 and bottom half pedestal 12 are secured with the cap screws 14. This completes the bearing seats 18, and they encircle the bearing 4.

Thereupon, the bearing 4 is adjusted. To this end, the cup 24 is advanced and retracted in the bearing seat 18 by rotating the bearing 4 using the adjustment tool 58 until the correct bearing setting is achieved. The setting for the bearing 4 is controlled by the spacing between the effective center of bearing assembly A and the effective center of bearing assembly B. The effective center of a bearing assembly is determined by drawing a perpendicular line from the center of the raceway 40 to the axis X. This point on the axis X is the effective center of the bearing assembly. The distance between the effective centers of the bearing assemblies A and B is referred to as the effective spread.

The fit between the cylindrical surface 38 of each cup 24 and the truncated crests of the thread 22 for the seat 18 in which that cup 24 is contained is tighter than the fit between the thread 36 in the cup 24 and the thread 22 of the bearing seat 18. More specifically, the clearance between the truncated crests of the internal thread 22 and the cylindrical surface 38 of the cup 24 is less than the difference between the pitch diameters of the internal thread 22 of the bearing seat 18 and the external thread 36 on the cup 24, the former being larger than the latter. The arrangement is such that radial and tilting loads transfer from the bearing 4 to the housing 2 through the cylindrical surfaces 38 on the cup 24. Axial or thrust loads, on the other hand, transfer between the bearing 4 and housing 2 through the engaged threads 22 and 36 on the bearing seat 18 and cup 24. The difference in the fit between the pitch diameters and between the cylindrical surface 38 and the crest of the threads 22 should range between 0 and 0.0185 inches.

Other variations are available as well. For example, the internal thread 22 of each bearing seat 18 need not extend the full length of the seat 18, but instead may lead up to a smooth cylindrical surface. That surface would lie opposite cylindrical surface 38 of the cup 24 that locates with the seat 18. The threads 22 and 36 in the bearing seat 18 and on the cup 24, respectively, are actually helices, and other forms of helices may be used, such as ball screws. Also, other bearings with inclined raceways—for example, angular contact ball bearing—may be substituted for the tapered roller bearing 4. In that event, the outer races of the substituted bearings would have threads 36 and cylindrical surfaces 38.

In other embodiments, the antirotational locking device 8 may assume any of a variety of configurations. Moreover, it may be attached to the cup 24 by a variety of methods, including, adhesives, screws, pins, and the like, at a variety of locations, including the back face 34, the front face, or the cylindrical surface 38.

In other embodiments, the housing can be embodied in the form of a one-piece housing. Also, the antirotational locking device could be used in a differential, on a pinion shaft, or any other shaft using threaded cups in a direct mounting or an indirect mounting.

Changes can be made in the above constructions without departing from the scope of the invention, it is intended that all matter contained in the above description or shown in the accompanying drawings shall be interpreted as illustrative and not in a limiting sense.

1. An anti-rotational locking device for a roller bearing assembly, comprising:
an annular ring attached to an outer race of the roller bearing assembly;
an outer lip extending from the annular ring;
an inner lip extending from the annular ring, the inner lip being capable of engagement by a tool for adjusting the bearing setting within a housing of the roller bearing assembly; and
a fastener being capable of engaging the outer lip to secure the bearing assembly at a desired bearing setting.

2. The anti-rotational locking device of claim 1, wherein the outer race has a threaded surface that engages a threaded seat of the housing.

3. The anti-rotational locking device of claim 2, wherein the threaded surface of the outer race occupies about 33% to about 50% of the length of the outer surface of the outer race.

4. The anti-rotational locking device of claim 1, wherein the fastener comprises a set screw advanced through a threaded hole of the housing until the set screw engages the outer lip.

5. The anti-rotational locking device of claim 1, wherein the fastener comprises a self-tapping screw drilled through an unthreaded hole of the housing until the self-tapping screw engages the outer lip.

6. The anti-rotational locking device of claim 1, wherein the tool comprises a disk having tabs that engage notches of the inner lip.

7. The anti-rotational locking device of claim 6, wherein the tool further comprises incremental marks that provide a visual aid for achieving the desired bearing setting for the bearing assembly.

8. The anti-rotational locking device of claim 1, wherein the roller bearing assembly further comprises:
an outer race having a threaded outer surface being capable of engagement with a threaded housing;
an inner race located within the outer race, the inner race being capable of engagement with a shaft; and
rolling elements arranged between the outer race and the inner race.

9. An anti-rotational roller bearing assembly, comprising:
an outer race having a threaded outer surface being capable of engagement with a threaded housing;
an inner race located within the outer race, the inner race being capable of engagement with a shaft;
rolling elements arranged between the outer race and the inner race;
an anti-rotational locking device attached to the outer race, the locking device being capable of engagement by a tool for adjusting a bearing setting of the roller bearing assembly within the threaded housing; and
a fastener being capable of engaging the anti-rotational locking device to secure the bearing assembly at a desired bearing setting.

10. The anti-rotational roller bearing assembly of claim 9, wherein the anti-rotational locking device comprises:
an annular ring attached to the outer race;
an outer lip extending from the annular ring; and
an inner lip extending from the annular ring, the inner lip having notches being capable of engagement by a tool for adjusting the bearing setting of the roller bearing assembly within the threaded housing.

11. The anti-rotational locking device of claim 9, wherein the fastener comprises a set screw advanced through a threaded hole of the threaded housing until the set screw engages the outer lip.

12. The anti-rotational locking device of claim 9, wherein the fastener comprises a self-tapping screw drilled through an unthreaded hole of the threaded housing until the self-tapping screw engages the outer lip.

13. The anti-rotational locking device of claim 9, wherein the threaded surface of the outer race occupies about 33% to about 50% of the length of the outer surface of the outer race.

14. A method of securing a bearing assembly within a housing at a desired bearing setting, the bearing assembly having an outer race with a threaded outer surface, an inner race located within the outer race, rolling elements arranged between the outer race and the inner race, and an anti-rotational locking device attached to the outer race, the method comprising the steps of:
engaging the threaded outer surface of the outer race with a threaded surface of the housing;
engaging the anti-rotational locking device with a tool;
rotating the tool and the engaged anti-rotational locking device to advance or retract the bearing assembly within the housing until the bearing assembly reaches a desired bearing setting; and
securing the bearing assembly at the desired bearing setting with a fastener.

15. The method of claim 14, wherein the step of securing the bearing assembly, further comprises the step of advancing a set screw through a threaded hole of a housing until the set screw engages the outer lip.

16. The method of claim 14, wherein the step of securing the bearing assembly, further comprises the step of advancing a self-tapping screw through an unthreaded hole of a housing until the self-tapping screw engages the outer lip.
